(19) United States
(12) Patent Application Publication
(10) Pub. No.: US 2009/0014619 A1
(43) Pub. Date: Jan. 15, 2009

(54) Multi adjustment for motor vehicle restriant positioning device

(76) Inventor: Bao-Chuan Wang, Taipei (TW)

Correspondence Address: Bao-Chuan Wang, P.O.Box 166-13, Taipei, 115, TW

(21) Appl. No.: 11/822,572

(22) Filed: Jul. 9, 2007

(51) Int. Cl. B60R 22/12

(52) U.S. Cl. 248/503

(57) ABSTRACT

The purpose of development is to provide advanced safety seatbelt restraint system positioning device for different body sizes; it can equip more than one positioning device to lateral sides of seats backrest, or interior plastic kit. The positioning device (1) includes a base (12) and a positioning block (11) fixed to a lateral side of the backrest (31), the positioning block (11) oriented in the same direction as the base (12), a top end of the positioning block (11) is integrally assembled to the base (12), a bottom end of the positioning block (11) and the base (12) are integrally formed as a slot (13) for passing through a seatbelt (41); the seatbelt (41) led into the slot (13) is buckled by the positioning block (11).

### FIELD OF THE INVENTION

The present invention is related to a multi-point seatbelt for motor vehicle restraint system positioning safety device, in particular to car seats.

### DESCRIPTION OF THE PRIOR ARTS

Recently, amount of cars manufactured and their speeds increased rapidly. More and more occupants and auto factories pay attention to safety device about cars. Once accidents happened, occupants or users should know how to protect themselves. When the auto factories design and build the new vehicles, 3-point shoulder/lap seatbelt usually incorporated to the car seat as standard equipments to meet the safety requirements stipulated by the administrations. Not only a flexible structure is provided, but also safety for all is to be guaranteed.

Next, the seat with integral restraint is emphasized by some pretensioners or E-pretensioners as new components of seatbelt in some new cars, that is, a buckled seatbelt may be pulled out continually, but when an accident happened, the seatbelt may limit movements of the occupant in response to activation by a crash sensor, which activates a compression spring loaded within the seatbelt buckles. Thus the seatbelt restricts occupant's lap, waist and shoulders to lean forward. So it can reduce above 80% of injuring in car accidents after the occupant get in the car and automatically wear one's seatbelt.

Fastening seatbelt has some steps; firstly buckle a shoulder belt on the seatbelt, simultaneously a lap belt spans across occupant's lap portion, but leave occupant's belly portion not in contact with the lap belt or shoulder belt, movements of occupant's lower extremities are also limited; under normal condition, a buckle of the seatbelt should be operated properly beside the seat not to affect the occupant. A length of the seatbelt can be adjusted as desired. Making sure there are no knots entangled or an extra extension of belt coils around the occupant's neck portion; sometimes, adjust the seatbelt to a proper length is required.

Seatbelt fits nicely to torso length of adults. However, for small body sizes (like children), the shoulder belts could spans over their heads or shoulders. So the belt is out of use. Whether padded pillow or chair cushion added to the seat or not represents a trade-off relationship between adults/children get in the car. Persons skilled in the art have provided seatbelt instead of so called 3 point seatbelt, such as TW I239306, entitled “Seat belt guiding auxiliary device and juvenile car seat” to Kassai et al. published on Sep. 11, 2005, it taught that a seat base 20 placed under a occupant's hip with a pair of loop parts 30,40 extended to the occupant's hip then a waist portion, a triangular connecting member 50 connecting top ends of the loop parts to rear portions of the seat base. However, a height of the seat base 20 is pre-determined, lengths of the loop parts must be adjusted to adapt to the seat base. Under such circumstance, at least, a waist support pad 60 (as shown in FIG. 4) removably mounted onto an extended portion 21 of the seat base 20 added to support the occupant's waist portion, sometimes, necessitates a displacement activity of the occupant for changing one's sitting posture or the pad 60, otherwise the occupant may feel uncomfortable as belts also limit movements of occupant's lower extremities.

Or as TW M295063 entitled “An additional safety belt” to I-Chien Chen on Aug. 1, 2006, it taught that a spared belt is joined together to a seatbelt by a buckle assembly, and this spared belt extended from the seatbelt fits nicely to a torso length of a occupant. However, the buckle assembly is mainly formed as an opening with a sawteeth shaped clip clamped onto the seatbelt at a selected location. The spared belt is thus added to the seatbelt, where the sawteeth clip may damage the seatbelt, and the spared belt is easily dropped off from the seatbelt.

Accordingly, how to provide a seatbelt with simple style, comfortable, and safety for all is concerned by the occupants and manufacturers.

### SUMMARY OF THE INVENTION

The present invention is to provide a seatbelt is to customize the positioning device without changing original seatbelt structure to fix the seatbelts on the seats, side-doors' interior plastic kit, In a quick, safe, easy way to fit different body sizes of occupants.

Point against aforesaid problems, the invention is to provide Multi adjustment for motor vehicle restraint positioning device characterized in that: at least, a positioning device (1) disposed to a lateral side of a seat (3) backrest (31), the positioning device (1) includes a base (12) and a positioning block (11) fixed to a lateral side of the backrest (31), the positioning block (11) oriented in the same direction as the base (12), a top end of the positioning block (11) is integrally assembled to the base (12), a bottom end of the positioning block (11) and the base (12) are integrally formed as a slot (13) for passing through a seatbelt (41); the seatbelt (41) led into the slot (13) is buckled by the positioning block (11).

Multi adjustment for motor vehicle restraint positioning device characterized in that: at least, a positioning device (1) disposed to an interior plastic kit (51) of a door (5) higher than chairs cushion (32), the positioning device (1) includes a base (12) and a positioning block (11) fixed to a lateral side of a seat backrest, the positioning block (11) is oriented in the same direction as the base (12), a top end of the positioning block (11) is integrally assembled to the base (12), a bottom end of the positioning block (11) and the base (12) are integrally formed as a slot (13) for passing through a seatbelt (41), the seatbelt (41) led into the slot (13) is buckled by the positioning block (11).

Multi adjustment for motor vehicle restraint positioning device as mentioned above wherein the base (12) of the positioning device (1) is flat.

Multi adjustment for motor vehicle restraint positioning device as mentioned above wherein the positioning device (1) is fixed to a left side or a right side of the backrest (31) of the seat (3).

Multi adjustment for motor vehicle restraint positioning device as mentioned above wherein the base (12) of the positioning device (1) is L-shaped, a top end of the positioning block (11) is assembled to an upper base (14), but a slot (13) is formed between a bottom end of the positioning block (11) and a lower base (14′), the slot (13) is designed for passing through the seatbelt (41).

Multi adjustment for motor vehicle restraint positioning device as mentioned above wherein the positioning device (1) is fixed to a front corner of the lateral side of the seat (3) backrest (31).

Multi adjustment for motor vehicle restraint positioning device as mentioned above wherein more than one positioning devices (1) can be added to the seatbelt, a certain gap must be kept between each two adjacent positioning devices (1).

### BRIEF DESCRIPTION OF DRAWINGS OF THE INVENTION

FIG. 1: is a perspective view of a first embodiment of multi-point seatbelt.

FIG. 2: is a schematic view of FIG. 1.

FIG. 3: is a perspective view of second embodiment of the positioning device.

FIG. 4: is a schematic view of FIG. 3.

FIGS. 5-7: are schematic views of the positioning device in practice of FIG. 1.

FIG. 8: is a schematic view of the positioning devices in practice of FIG. 2.

FIGS. 9-10: are schematic views of the positioning device in practice of FIG. 3.

FIG. 11: is a schematic view of the positioning device in practice of FIG. 4.

FIG. 12: is a schematic view of comparison between the invention and prior art.

FIGS. 13˜14: are schematic views of movable positioning device.

### DETAILED DESCRIPTION OF THE PREFERRED EMBODIMENTS OF THE INVENTION

Detailed description is described in detail according to the appended drawings hereinafter.

### First Embodiment

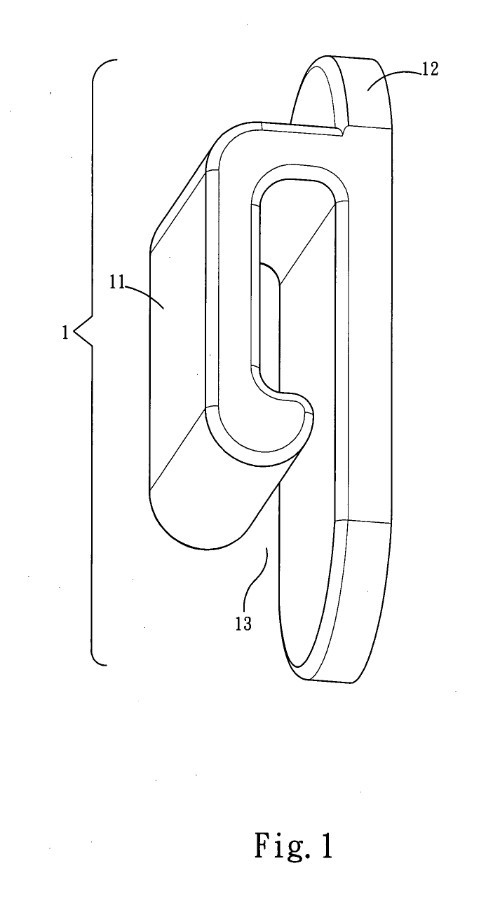

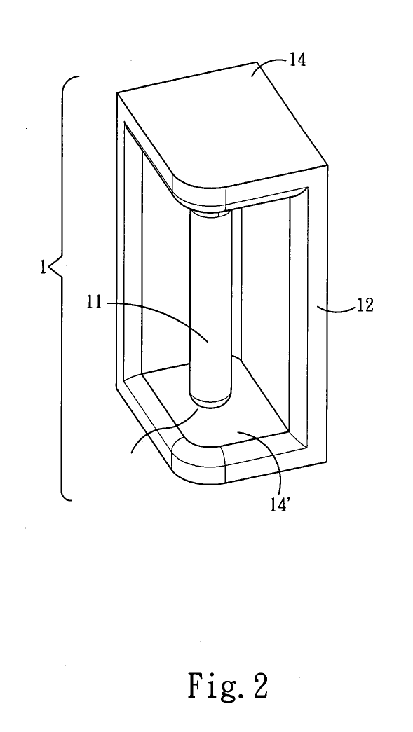

As shown in FIGS. 1 and 2, multi adjustment for motor vehicle restraint positioning device includes a positioning device (1), a base (12), a positioning block (11) disposed to a lateral side of the base (12), and the positioning block (11) is oriented in the same direction as the base (12). A top end of the positioning block (11) is integrally assembled to the base (12) as a whole. A slot (13) formed between a bottom end of the positioning block (12) and the base (12) allows a seatbelt (41) passing through. The base (12) of the positioning device is flat so that the base (12) can be added to lateral sides, either left side or right side of the seat backrest.

As shown FIG. 2, the positioning device (1) is different from the same of FIG. 1 by an L-shaped base (12), further flat bases (14.14′) incorporated to the L-shaped base (12). A top end of the positioning block (11) is assembled to an upper base (14). A bottom end of the positioning block (11) is not in contact with a lower base (14′), thereby formed into a slot (13) allows the seatbelt (41) passing through. The positioning device (1) is proper to fix on a front corner of lateral sides of seat (3) backrest (31).

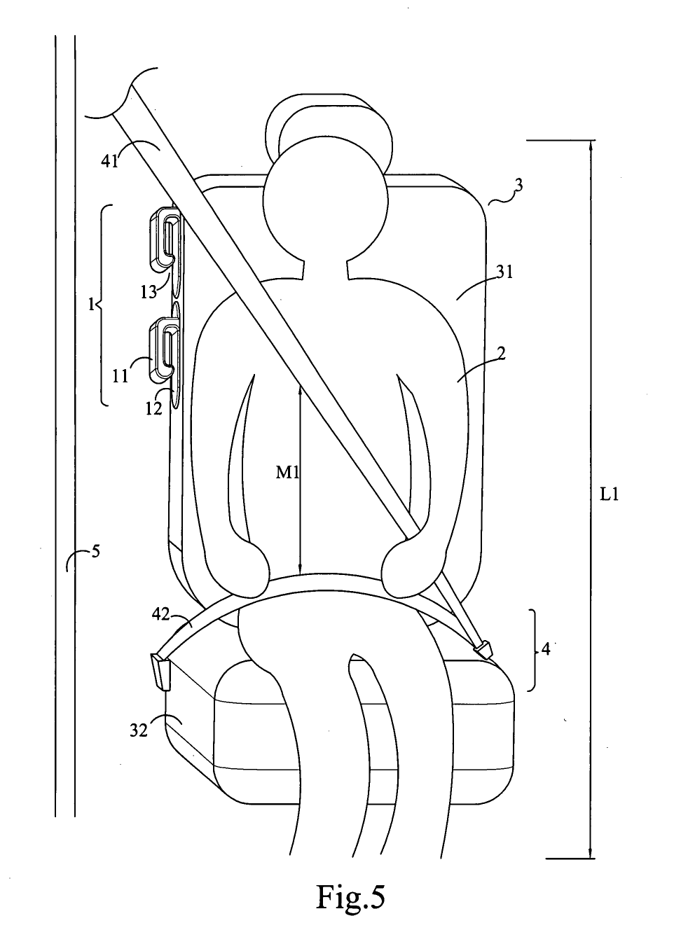

As shown in FIG. 5 to FIG. 7, schematic views of the positioning device in practice are illustrated. Two positioning devices (1) disposed to a lateral side of the seat (3) backrest (31). A distance is kept between two adjacent positioning devices (1). Both two positioning devices (1) are fixed to the same lateral side of the seat backrest.

As shown in FIG. 5, when a occupant (2), whose body height L1 is over 160 centimeters, sit on the seat (3), the belt (41) spans across a torso length, a belt (42) spans across the lap. A topmost portion of the belt (41) is distant to a bottommost portion of the belt (42) about 55 centimeters, which is designated as M1.

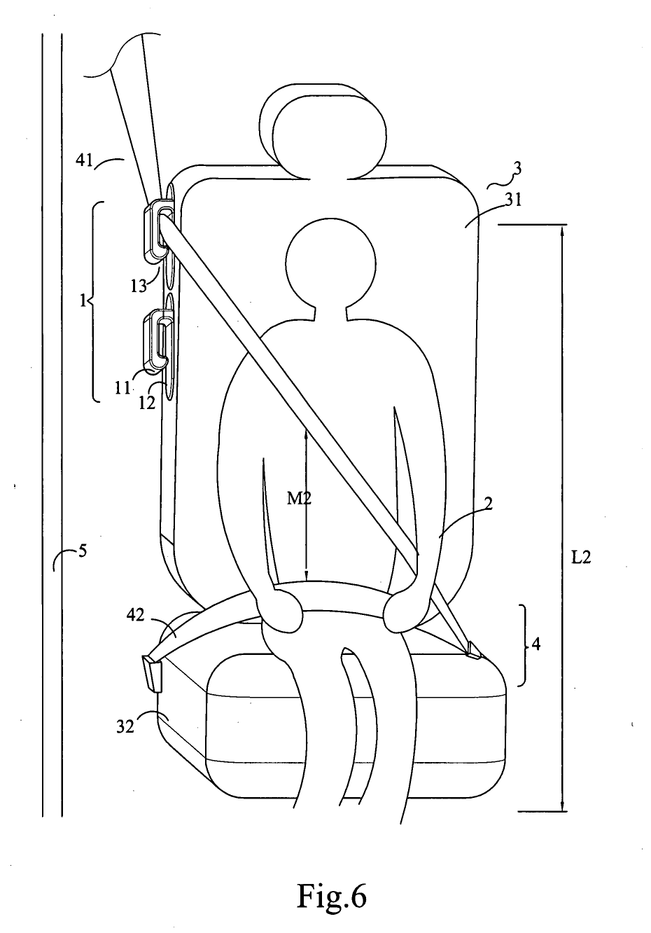

In FIG. 6, when a occupant (2), whose body height L2 is in the range of from 145 to 160 centimeters, sit on the seat (3), the seatbelt (41) is pulled out to pass through the positioning block (11) of an upper positioning device (1). Then the seatbelt (41) spans across a torso length, and a belt (42) spans across the occupant's lap portion. A topmost portion of the belt (41) is distant to a bottommost portion of the belt (42) about 47 centimeters, which is designated as M2.

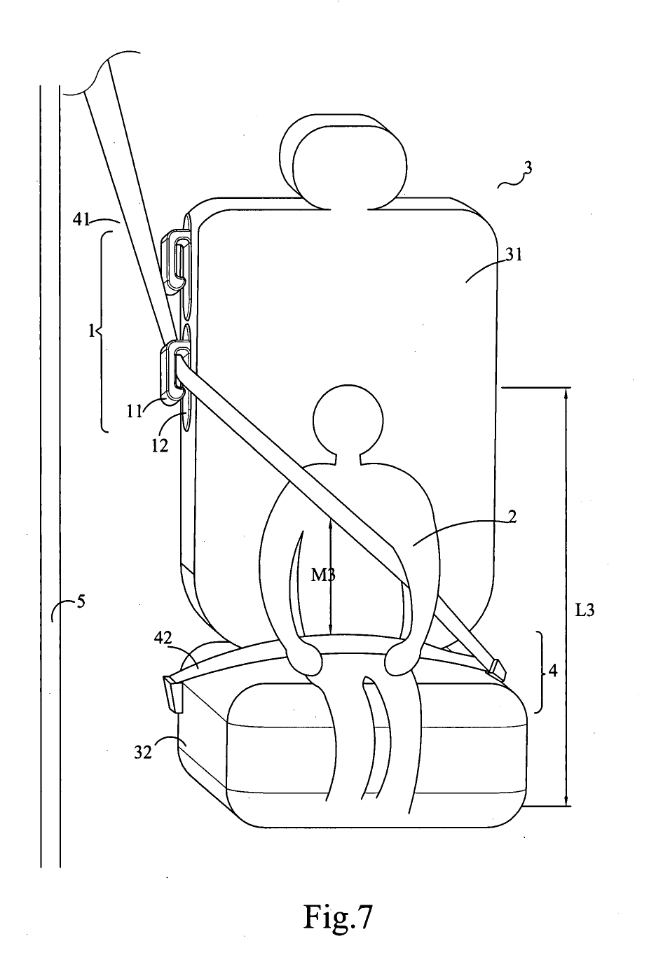

As shown in FIG. 7, when a occupant, (2) whose body height L3 is in the range of from 120 to 144 centimeters, sit on the seat (3), the belt (41) is pulled out to pass through a positioning block (11) of lower positioning device (1) then spans across a torso length. A topmost portion of the belt (41) is distant to a bottommost portion of the belt (42) about 40 centimeters, which is designated as M3.

In practice, the two positioning blocks (1) selectively combined to the seatbelt (4) can be used likely 3 point shoulder/lap seatbelt to ensure safety for all. Furthermore, because the belt (41) can be selectively pulled out from an upper or a lower positioning block (1), further being stretched over a torso length, whereby the belt 41 has no knots entangled or an extra extension of belt coils around the occupant's neck portion. However, the invention is not restricted to 3-point seatbelt. 2-point, 4-point or even multi-point can also be practiced. But the two positioning blocks is preferably incorporated to 2 point or 3 point seatbelt.

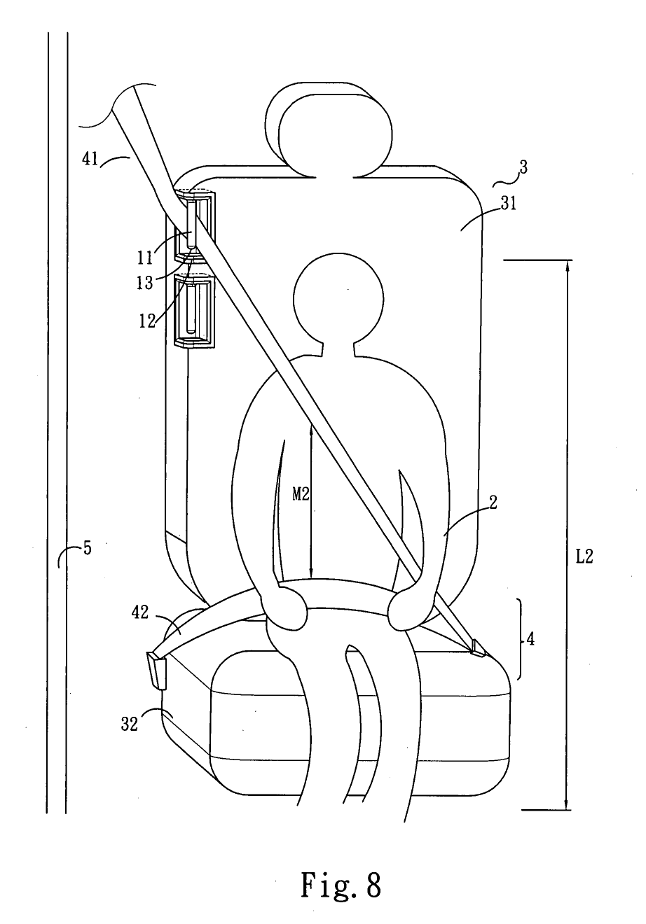

As shown in FIG. 8, the positioning device (1) fixed to a front corner of a lateral side of seat backrest. Configuration of the positioning device (1) is the same as depicted in FIG. 2, also its performance and function are also shown in FIGS. 6 and 7.

### Second Embodiment

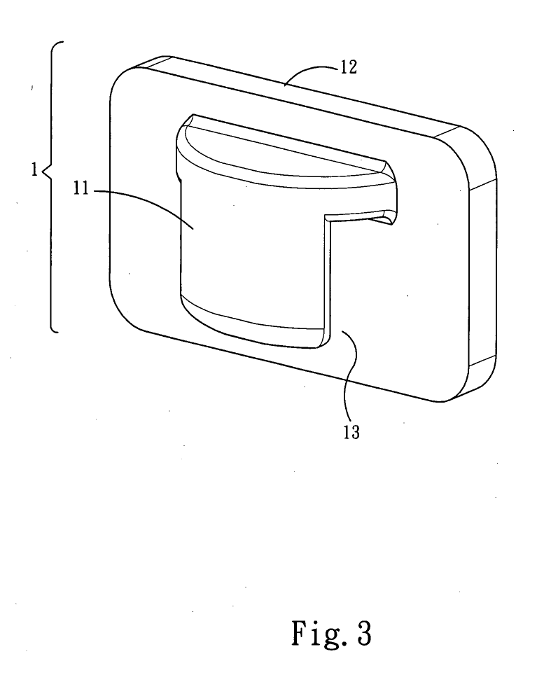

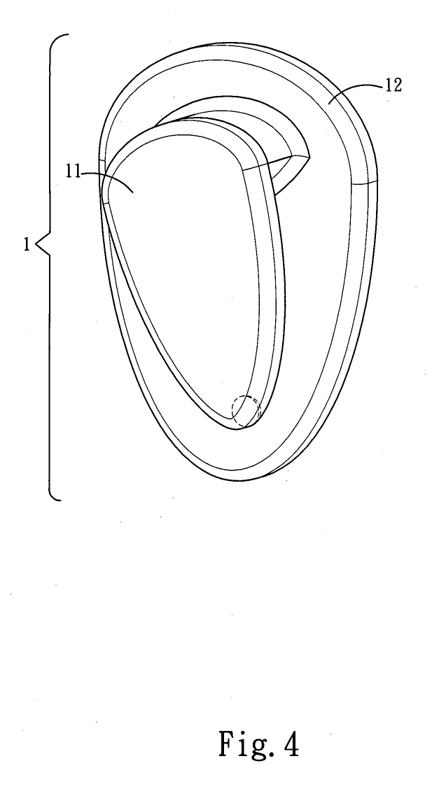

As shown in FIGS. 3 and 4, perspective views of a second embodiment of the invention are illustrated, where the positioning device (1) is similar to the positioning device (1) of FIG. 1. The positioning block (11) in FIG. 3 is semi-circular in shape projecting out from an outer wall of the positioning device (1) with a flap extended downward, a slot (13) is formed between the flap and the positioning device (1) for passing through the belt (41). In FIG. 4, the positioning block (11) is also semi-circular in shape projecting out from the outer wall of the positioning device (1), where an outstretched arm tapered downward is magnetically attracted to the positioning device (1) by a permanent magnet installed to a bottom end of the arm with a slot formed therebetween for passing through the belt (41).

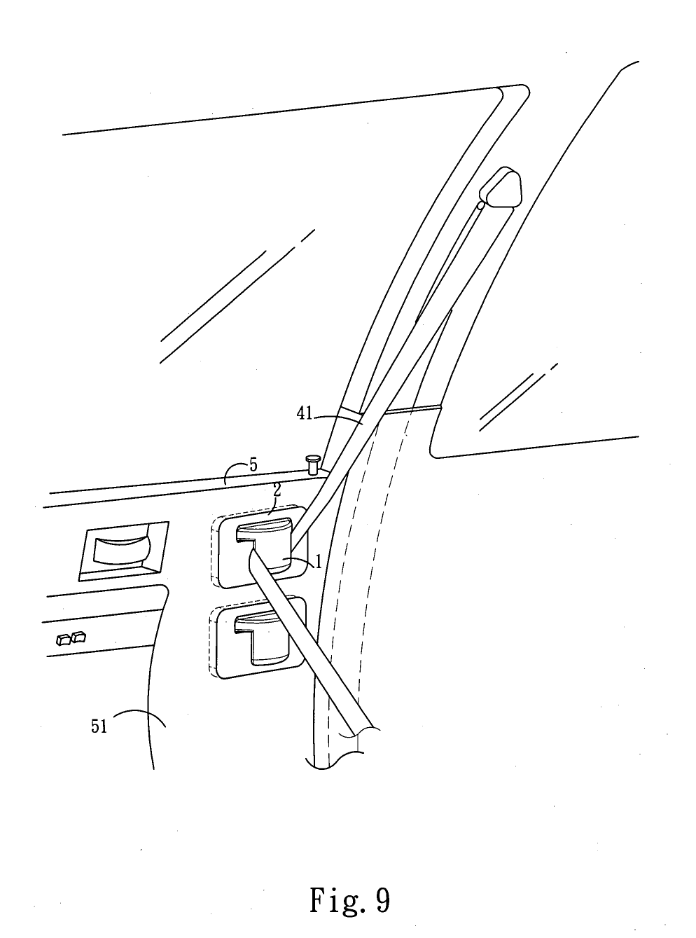

As shown in FIG. 9, the positioning device (1) as depicted in FIG. 3 is coupled to an interior plastic kit (51) of a door (5) higher than a seat cushion (32) by welding or bolting. When a occupant (2), whose body height L2 is in the range of from 145 to 160 centimeters, sits on the seat, the belt (41) goes through an upper positioning device (1) on the interior plastic kit (51), and then spans across a torso length, whereby the belt 41 has no knots entangled or an extra extension of belt coils around the occupant's neck portion.

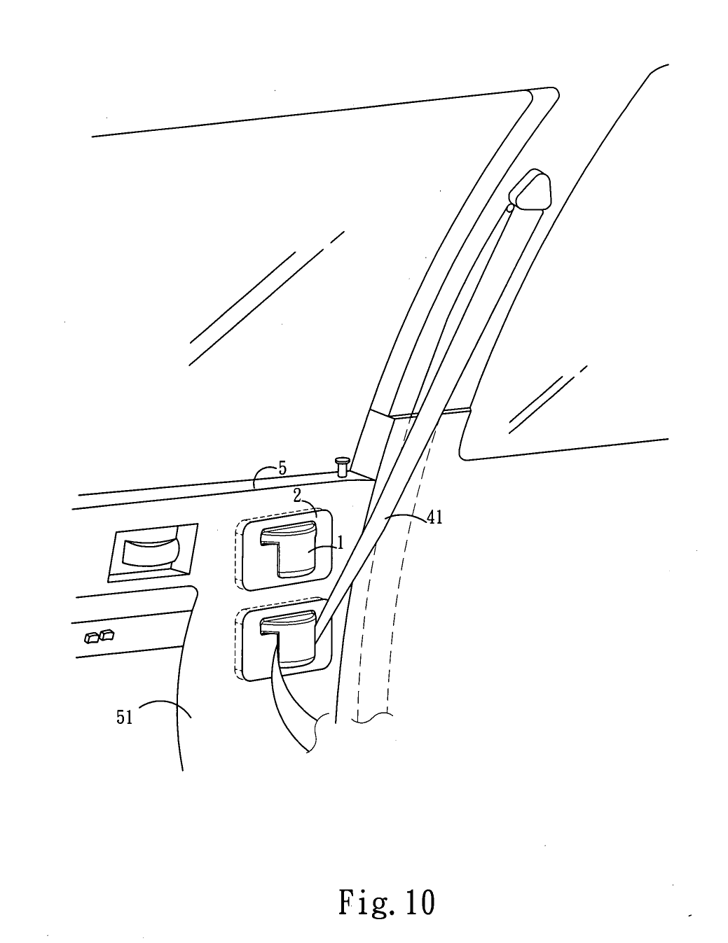

As shown in FIG. 10, when a occupant, whose body height L3 is in the range of from 120 to 145 centimeters, sits on the seat, the belt (41) goes through a lower positioning device (1) on the interior plastic kit (51), and then spans across a torso length, whereby the belt 41 has no knots entangled or an extra extension of belt coils around the occupant's neck portion.

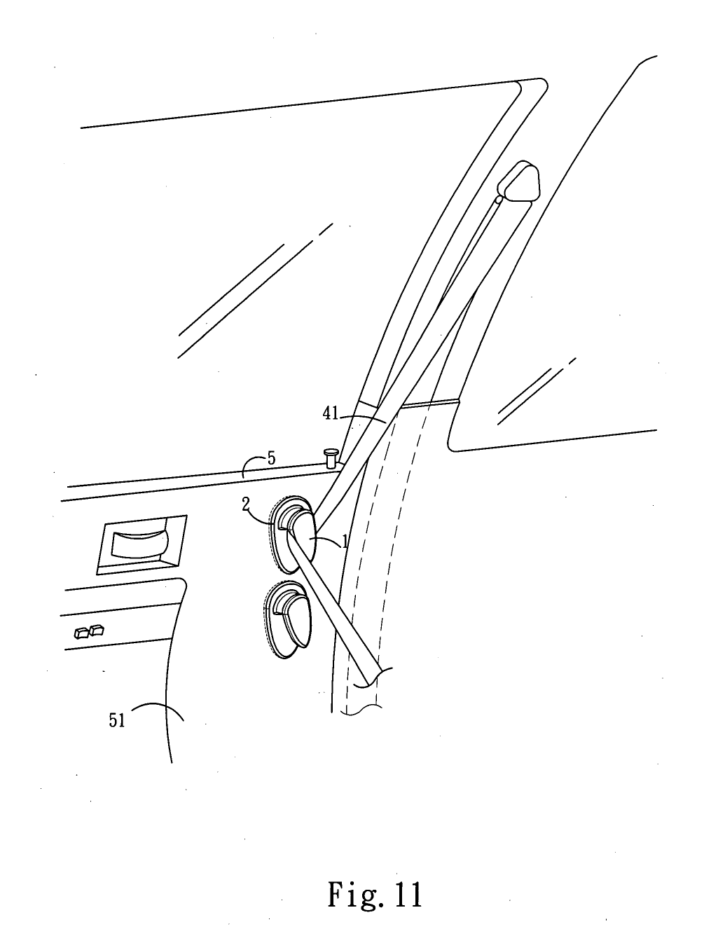

As shown in FIG. 11, the positioning device (1) as depicted in FIG. 4 is coupled to the interior plastic kit (51) higher than a seat cushion (32) by welding, bolting.

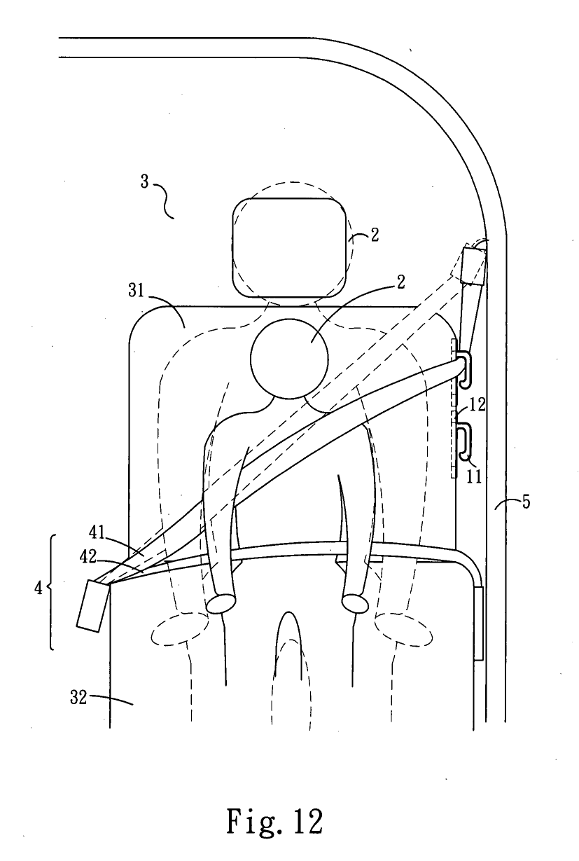

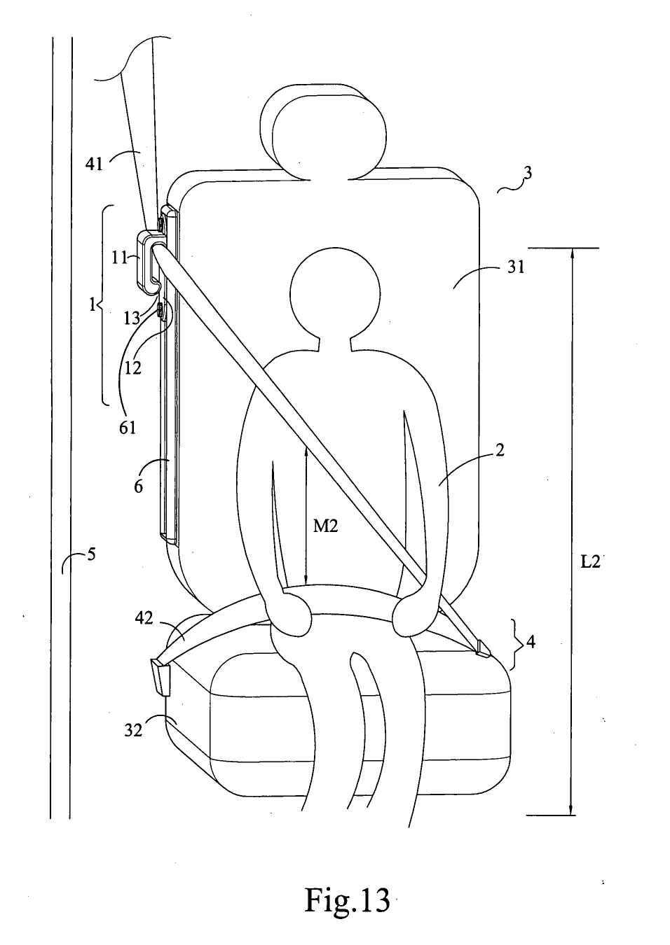

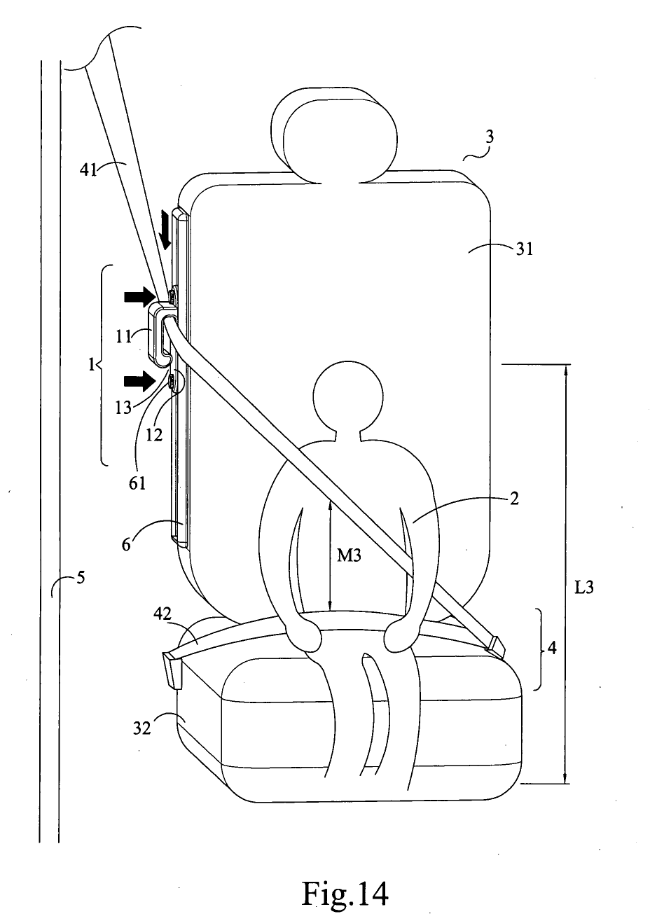

As shown in FIG. 12, comparison between the invention and conventional seatbelt, a occupant (2) has body height L3 about 120 to 144 centimeters, sits on the seat without the positioning device (1) to adjust the belt (41) to fit nicely a torso length, where the belt (41) may have knots entangled or an extra extension of belt coils around the occupant's neck portion. It may cause immediate risk to the occupant, especially children.

Moreover, the positioning device (1) can be movably adjusted on a rail, which is pre-connected to a lateral side of seat backrest, the positioning device (1) is embedded into the rail by two knobs, one of them secured on a top of the positioning device (1) to the rail, the other secured below a bottom of the positioning device to the rail. The positioning device (1) must be moved upward or downward along the rail, till both knobs are loose. Only one positioning device on the rail can be used instead of multi positioning devices.

Advantages can be achieved by the invention as following: a positioning device (1) disposed to a lateral side of a seat backrest, a belt (41) pulled out to pass through a slot (13) between the positioning device (1) and a positioning block (11) in position. That is, the belt (41) still can be led in or pulled out the slot (13). The belt (41) has a mutually agreeable and compatible lengthwise adjustment by about 5˜10%, but not lateral adjustment, due to the positioning device is positioned according to the occupant's torso length in advance. Not only the belt is not possibly to slide out of the slot, but also span across a torso length with a pulled straight force.

What is claim claimed:

1. Multi adjustment for motor vehicle restraint positioning device characterized in that: at least, a positioning device (1) disposed to a lateral side of a seat (3) backrest (31), the positioning device (1) includes a base (12) and a positioning block (11) fixed to a lateral side of the backrest (31), the positioning block (11) oriented in the same direction as the base (12), a top end of the positioning block (11) is integrally assembled to the base (12), a bottom end of the positioning block (11) and the base (12) are integrally formed as a slot (13) for passing through a seatbelt (41); the seatbelt (41) led into the slot (13) is buckled by the positioning block (11).

2. Multi adjustment for motor vehicle restraint positioning device as claim 1 claimed wherein the base (12) of the positioning device (1) is flat.

3. Multi adjustment for motor vehicle restraint positioning device as claim 2 claimed wherein the positioning device (1) is fixed to a left side or a right side of the backrest (31) of the seat (3).

4. Multi adjustment for motor vehicle restraint positioning device as claim 1 claimed wherein the base (12) of the positioning device (1) is L-shaped, a top end of the positioning block (11) is assembled to an upper base (14), but a slot (13) is formed between a bottom end of the positioning block (11) and a lower base (14′), the slot (13) is designed for passing through the seatbelt (41).

5. Multi adjustment for motor vehicle restraint positioning device as claim 4 claimed wherein the positioning device (1) is fixed to a front corner of the lateral side of the seat (3) backrest (31).

6. Multi adjustment for motor vehicle restraint positioning device as claim 1 claimed wherein more than one positioning devices (1) can be added to the seatbelt, a distance is kept between each two adjacent positioning devices (1).

7. Multi adjustment for motor vehicle restraint positioning device characterized in that: at least, a positioning device (1) disposed to an interior plastic kit (51) of a door (5) higher than chairs cushion (32), the positioning device (1) includes a base (12) and a positioning block (11) fixed to a lateral side of a seat backrest, the positioning block (11) is oriented in the same direction as the base (12), a top end of the positioning block (11) is integrally assembled to the base (12), a bottom end of the positioning block (11) and the base (12) are integrally formed as a slot (13) for passing through a seatbelt (41), the seatbelt (41) led into the slot (13) is buckled by the positioning block (11).

8. Multi adjustment for motor vehicle restraint positioning device as claim 7 claimed wherein the positioning device's (1) base (12) is flat.

9. Multi adjustment for motor vehicle restraint positioning device as claim 8 claimed wherein the positioning device (1) fixed on the right or left interior plastic kit (51).

10. Multi adjustment for motor vehicle restraint positioning device as claim 7 claimed wherein the base (12) of the positioning device (1) is L-shaped, a top end of the positioning block (11) is assembled to an upper base (14), but a slot (13) is formed between a bottom end of the positioning block (11) and a lower base (14′), the slot (13) is designed for passing through the seatbelt (41).

11. Multi adjustment for motor vehicle restraint positioning device as claim 10 claimed wherein the positioning device (1) is fixed to a front corner of the lateral side of the seat (3) backrest (31).

12. A multi-point seatbelt as claim 7 claimed wherein more than one positioning devices (1) can be added to the seatbelt, a distance is kept between each two adjacent positioning device.

13. A multi-point seatbelt characterized in that: one positioning device (1) on a rail fixed to a lateral side of seat backrest, the positioning device (1) is embedded into the rail by two knobs, one is secured on a top of the positioning device, the other is secured below a bottom of the positioning device; the positioning device (1) can be movably adjusted on the rail instead of more than one positioning device (1).
